(19) United States
(12) Patent Application Publication
(10) Pub. No.: US 2024/0015778 A1
(43) Pub. Date: Jan. 11, 2024

(54) METHOD AND APPARATUS FOR DETERMINING CHANNEL QUALITY AND ASSISTING OPERATION OF A CBRS WIRELESS COMMUNICATION NETWORK

(71) Applicant: Celona, Inc., Campbell, CA (US)

(72) Inventors: VANLIN SATHYA, Campbell, CA (US); SRINIVASAN BALASUBRAMANIAN, San Diego, CA (US)

(21) Appl. No.: 18/347,525

(22) Filed: Jul. 5, 2023

Related U.S. Application Data
(60) Provisional application No. 63/388,065, filed on Jul. 11, 2022.

(51) Int. Cl. H04W 72/542; H04W 16/14

(52) U.S. Cl. CPC H04W 72/542; H04W 16/14

(57) ABSTRACT

A method and apparatus are disclosed for determining channel quality in a Citizens Broadband Radio Service (CBRS) network and utilizing the channel quality information to improve network performance. Citizens Broadband Radio Service Devices (CBSDs) deployed in the Enterprise Network (EN), and User Equipment (UEs) connected to the EN are controlled to silently listen to the network without disruption of communications. The resulting data is collected by the EN and can be passed to the neighboring enterprise or SAS for channel allocation and power control assistance.

### CLAIM OF PRIORITY TO PREVIOUSLY FILED PROVISIONAL APPLICATION—INCORPORATION BY REFERENCE

This non-provisional application claims priority to an earlier-filed provisional application No. 63/388,065 filed Jul. 11, 2022, entitled “Method and Apparatus for Determining Channel Quality and Assisting Operation of a CBRS Wireless Communication Network” (ATTY DOCKET NO. CEL-074-PROV) and the provisional application No. 63/388,065 filed Jul. 5, 2022, and all its contents, are hereby incorporated by reference herein as if set forth in full.

### BACKGROUND

### Technical Field

The disclosed method and apparatus relate generally to wireless networks for enterprises, and particularly to techniques for measuring channel quality for wireless channel management of the Radio Access Network (RAN) of CBRS networks.

### Background

The wireless industry has experienced tremendous growth in recent years, with rapidly improving technology, faster and more numerous broadband communication networks are being installed around the globe. Wireless networks have now become key components of a worldwide communication system that connects people and businesses at speeds and on a scale unimaginable just a couple of decades ago, and these. In wireless systems, multiple mobile devices are served voice services, data services, and many other services over wireless connections so they may remain mobile while still connected.

### Communication Network Configurations

FIG. 1 is an illustration of a basic configuration for a communication network 100, such as a “4G LTE” (fourth generation Long-Term Evolution) or “5G NR” (fifth generation New Radio) network. Through this network configuration, user equipment (UE) 101 can connect to External Packet Data Networks (PDNs) 103 and access any of a variety of services such as the Internet, Application Servers, Data Services, Voice Services, and others.

### UES, BS/APS, RAN

“UEs”, or “devices”, or “UE devices” can be used to refer to a wide range of user_devices having wireless connectivity, such as a cellular mobile phone, an Internet of Things (IOT) device, virtual reality goggles, robotic devices, autonomous driving machines, smart barcode scanners, and communications equipment including desktop computers, laptop computers, tablets, and other types of personal communications devices. In the illustration of FIG. 1, the UEs 101 include a first mobile phone 101a, a second mobile phone 101b, a laptop computer 101c (which can be moved around), and a printer 101d (typically situated at a fixed location).

The UEs 101 connect wirelessly over radio communication links 105 to a Radio Access Network (RAN) 107 that typically includes multiple base station/access points (BS/APs) 109. One of the advantages of such wireless networks is their ability to provide communications to and from multiple wireless devices and provide these wireless devices with access to a large number of other devices and services even though the devices may be mobile and moving from location to location.

The term ‘BS/AP” is used herein to include Base Stations and Access Points. The BS/APs may include an evolved NodeB (eNB) of an LTE network or gNodeB of a 5G network, a cellular base station (BS), a Citizens Broadband Radio Service Device (CBSD) (which may be an LTE or 5G device), a Wi-Fi access node, a Local Area Network (LAN) access point, and a Wide Area Network (WAN) access point.

### Core Network

The RAN 107 connects the UEs 101 with the Core Network 111, which provides an interface between the RAN 107 and other networks. The Core Network can have multiple functions; in one important function, the Core Network 111 provides access to other devices and services either within its network, or on other networks such as the External PDNs 103. Particularly, the UEs 101 are wirelessly connected to the BS/APs 109 in RAN 107, and the RAN 107 is coupled to the Core Network 111 utilizing any appropriate communication means, such as wireless, cable, and fiber optic. Thus, the RAN 107 and the Core Network 111 provide a system that allows information to flow between a UE in the cellular or private network and other networks, such as the Public Switched Telephone Network (PSTN) or the Internet.

In addition to providing access to remote networks and allowing information to flow between the cellular network and the external PDNs 103, the Core Network 111 includes RAN Control Units 113 that manage the wireless network and provide control of the air interface between the BS/AP 119 and the UEs 101. The Core Network 111 may also coordinate the BS/APs 109 to minimize interference within the network.

### CBRS Networks

One type of wireless network that recently became available for general use by enterprise locations is a Citizen's Broadband Radio Service (CBRS) network, which utilizes the CBRS radio band of 3550-3700 MHz, nominally divided into fifteen channels of 10 MHz each. Particularly, the US Federal Government recently approved use of the CBRS band of the frequency spectrum and finalized rules (Rule 96) that allow general access to the CBRS band. The CBRS rules set forth detailed requirements for the devices that operate in a CBRS network and how they communicate. CBRS supports both LTE and 5G devices. CBRS provides enormous wireless networking power to organizations that have never had such an option before and opens up and creates opportunities for a range of new applications; accordingly, there is a need to make efficient use of spectrum in the CBRS band while following the rules pertaining the CBRS usage.

FIG. 2 is a diagram of an example of a CBRS wireless communication network 200. In FIG. 2, a plurality of BS/APs 202 are deployed within a location 203 on the enterprise's campus, providing service to a plurality of UEs 204. In a CBRS system, the BS/APs may be termed CBSDs.

In FIG. 2, each BS/AP 202 has a range that represents its respective wireless coverage. A first UE 202a is wirelessly connected to a first BS/AP 204a, which is providing service to it. A second UE 204b is wirelessly connected to a second BS/AP 202b and is providing service to that second UE 204b. Other UEs 204 connect to their respective BS/APs, for example third UE 204c, fourth UE 204d, fifth UE 204e, sixth UE 204f, and seventh UE 204g are shown in the enterprise location 203. All the BS/APs are connected to an operator Core Network 222 by any appropriate communication means, such as wire, fiber optic, wireless radio and/or a PDN 220. The operator Core Network 222 includes components such as an OAM Server 207, a SON assist unit 208, a Domain Proxy 209, an Automatic Configuration Server (ACS) 210, a Location Database 211, and other databases 212, all of which are connected to each other within the operator Core Network 222 by any appropriate means.

Base stations (BS/APs) within a CBRS network are termed “CBSDs”, and UEs are termed End User Devices (EUDs). CBSDs are fixed Stations, or networks of such stations, that operate on a Priority Access or General Authorized Access basis in the Citizens Broadband Radio Service consistent with Title 47 CFR Part 96 of the United States Code of Federal Regulations (CFR).

### SAS

The operator Core Network 222 is connected to a Spectrum Access System (SAS) 232, which is connected to a Spectrum Database 233 that includes data regarding the spectrum that it is managing. Collectively, the SAS 232 and the Spectrum Database 233 are referred to as a Spectrum Management Entity (SME) 234. The SAS 232 is also connected to other CBRS networks, shown at 240. The CBRS rules require that the SAS 232 allocate spectrum to the CBSDs to avoid interference within the CBRS band. The SAS 232 provides a service, typically cloud-based, that manages the spectrum used in wireless communications of devices transmitting in the CBRS band in order to prevent harmful interference to higher priority users, such as the military and priority licensees, and other GAA users.

To allocate spectrum and maintain communication between the CBSDs and the SAS 232, a series of messages are exchanged with the CBSDs for purposes including registration, spectrum inquiry, grant, and heartbeat response. In a RAN that has multiple CBSDs, the Domain Proxy (DP) 209 in the CBRS networks may be implemented to communicate with the SAS and manage all transactions between the CBSDs and the SAS 232. The Spectrum Sharing Committee Work Group 3 (for CBRS Protocols) has established an interface specification for registering a CBSD with an SAS 232, requesting a grant of spectrum, and maintaining that grant. These message flows are described in the document titled “Signaling Protocols and Procedures for Citizens Broadband Radio Service (CBRS): Spectrum Access System (SAS)-Citizens Broadband Radio Service Device (CBSD) Interface Technical Specification”, Document WINNF-TS-0016-V1.2.4, 26 Jun. 2019.

### Allocation and Power Control

In any enterprise wireless network there is a need for efficient use of wireless resources, for cost reasons of course, but also to provide high levels of service to the UEs attached to the wireless network. In a CBRS network, the SAS allocates channels and power control requirements to General Authorized Access (GAA) users based on a number of factors. First priority is given to current incumbent and Priority Access Licenses (PALs). As to the GAA users, there are inefficiencies in the allocation and usage of channels. which is mainly due to the lack of reliable information of the GAA channel usage in the neighborhood. For example, it is very likely that the neighborhood channel usage of a given deployment will continue to change, in which case the GAA channel usage should change accordingly, and the enterprise networks should change or modify their channel operations for more efficient operation. However, the lack of reliable information on channel quality makes changing or modifying the channels difficult. It would be an advantage to provide channel quality information and improve the SAS assistance to the CBRS deployments, which would allow CBRS deployments to operate more efficiently.

### SUMMARY

In any enterprise wireless network there is a need for efficient use of wireless resources, for cost reasons of course, but also to provide high levels of service to the UEs attached to the wireless network. In other words, radio resource planning is crucial to provide the QoS promised by a mobile network provider.

A method and apparatus are disclosed herein for determining channel quality in a CBRS network, and utilizing the channel quality information to improve network performance. Useful information can be provided to an SAS and neighboring GAA networks so that the deployments can need to continue to monitor and adapt to the changes experienced around its deployment.

The CBSDs deployed in the EN, and UEs connected to the EN are controlled to silently listen to the network without disruption of communications. The resulting data is collected by the EN, and can be passed to the neighboring enterprise or SAS for channel allocation and power control assistance.

Furthermore, utilizing this information, a mechanism is described to assess the RF footprint of the neighboring deployments. Responsive to this information, SON optimizations and mechanisms can be utilized to optimize the channel assignments within the EN deployment.

Measurements and information collections are made while the network is actively being used. For optimal configuration of the channels for operation, the information can be captured multiple times during the day and week, such as during peak, moderate, and off-peak times.

Multiple advantages are provided:
The method and interference data can be collected and used pre- and post-deployment;
Leads to better channel and BW allocation; and
Helps in power control decisions.

In the described embodiment the enterprise wireless network operates on the Citizen's Broadband Radio Service (CBRS band), the BS/APs in the RAN comprise CBRS Devices (CBSDs) that are located at a campus location and form part of an enterprise network. In alternative implementations, other network architectures and other technologies, such as mm-wave, or spectrum purchased/licensed from others, could be utilized.

### BRIEF DESCRIPTION OF THE DRAWING

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of a basic configuration for a communication network, such as a “4G LTE” (fourth generation Long-Term Evolution) or “5G NR” (fifth generation New Radio) network.

FIG. 2 is a block diagram of a wireless communication network in which a CBRS system is implemented, including BS/APs deployed at an enterprise location, UEs wirelessly connected to them, and an operator network connected to a Spectrum Management Entity (SME).

FIG. 3 is a perspective illustration of a campus location in which a plurality of BS/APs of an Enterprise Network (EN) are installed to provide wireless coverage to a plurality of mobile users, and a plurality of campus locations of neighboring enterprise networks.

FIG. 4 is a cross-sectional view of a building on the campus location in which BS/APs are installed on different floors.

FIG. 5 is a block diagram showing an example of a CBRS network including an interconnected system of neighboring networks

FIG. 6 is an example of graph-based coloring for channel assignment.

FIG. 7 is an example of measurement within the same MNO.

FIG. 8 is a block diagram of an implementation of an Enterprise Network (EN) that includes units for allocating and reallocating RAN parameters.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

### (1) Enterprise Network

An implementation of an enterprise wireless communication network (EN) at a campus location is described herein. The term “enterprise” is used herein in its broadest sense to include any organization, such as businesses, research organizations, schools, colleges, hospitals, industry organizations, and any other organization, regardless of whether or not for profit. The term “campus” is used in its broadest sense to include any area in which the enterprise operates, such as the grounds and/or buildings operated or managed by the enterprise, college campuses, research centers, industrial complexes, any business or industrial site, and others.

An enterprise wireless communication network (EN) is a private network. Private networks are operated for use within a limited area by a limited group of authorized users, whereas public networks generally cover a larger area and are open for use by anyone that subscribes to the service by the network operator. One or more ENs can be created at a location such as a warehouse, factory, research center or other building, and are usually operated by an organization for its own use. Other types of private networks may be operated by a private network manager for use by more than one organization. Although described in the context of an enterprise wireless communication network, the principles disclosed can also apply to any private wireless network.

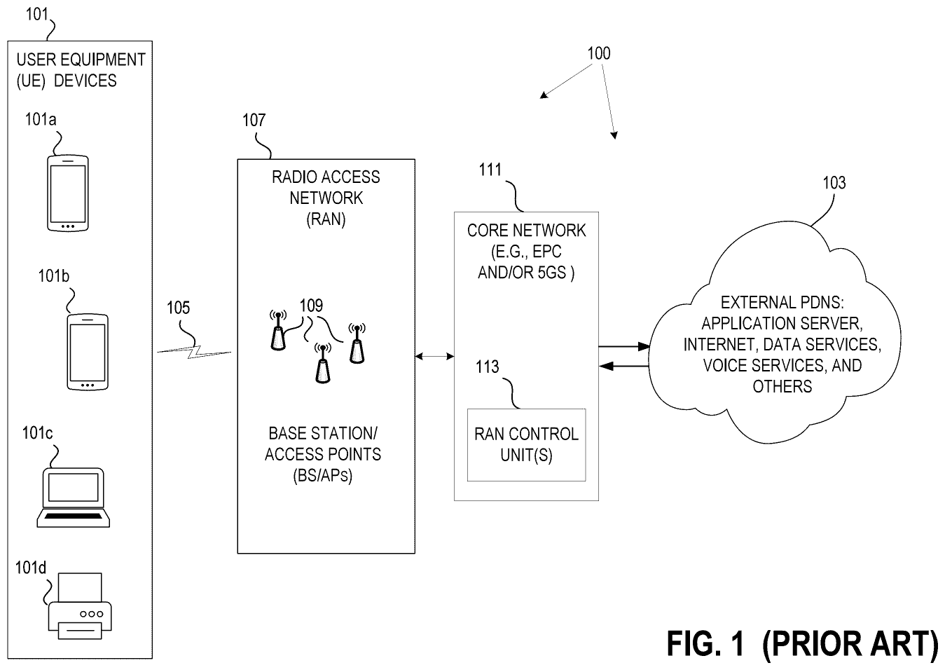

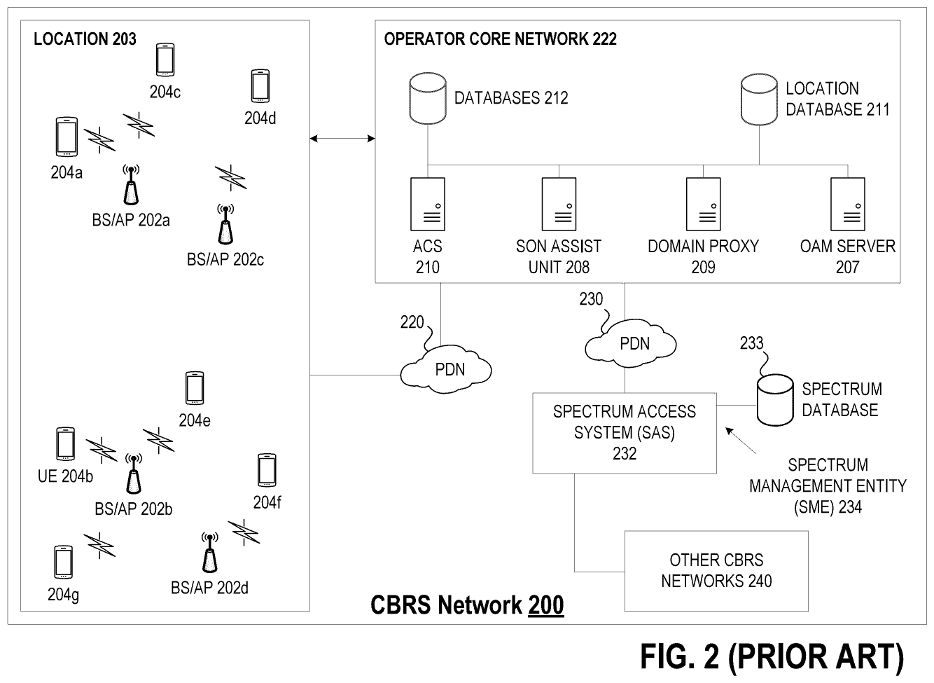

An EN may comprise any appropriate wireless network technology that can connect to UEs. For example, the LTE (4G) network shown in FIG. 1 and/or the NR (5G) Network shown in FIG. 2 can be implemented in an EN. In addition, the EN may also be implemented as a CBRS network using, for example, the LTE(4G) or NR(5G) technologies.

### (2) Communication Networks

Communication networks and system components may be described herein using terminology and components relating to 4G, 5G, and CBRS systems and their approved (registered) interfaces including 4G (LTE) (IEEE 802.16e), 5G NR 3GPP TS 38.300, E_UTRA (3GPP TS 36.300) communication systems. For instance, the term “CBSD” is one implementation of a Base Station/Access Point (BS/AP) and is used herein for descriptive purposes in the context of a CBRS system. The principles of the communication network described herein more widely apply to other communication networks and systems, and particularly to any spectrum-controlled communication system and network. In some embodiments, the enterprise wireless communication network operates on the CBRS band, and the BS/APs comprise CBRS devices (CBSDs) that are located at a campus location.

### (3) Acronyms

Some of the acronyms used herein are as follows:

ACS: Automatic Configuration Server

BFS: Breadth First Search

BS/AP: Base Station/Access Point

CBRS: Citizen's Broadband Radio Service

CBSD: CBRS Device

CDF: Cumulative Distribution Function:

DL: Downlink

ED: Energy Detection

EN: Enterprise Network

GAA: General Authorized Access

LTE: Long Term Evolution (4G)

NR: New Radio (5G)

PAL: Priority Access License

PCI: Physical Cell Identifier

PDN: Packet Data Network

PSS: Primary Synchronization Signal

RAN: Radio Access Network

RB: Resource Block

RF: Radio Frequency

RRC: Radio Resource Control

RSRP: Reference Signal Received Power (a measurement of the received power level in a wireless network)

RSRQ:

RSSI: Received Signal Strength Indication

SAS: Spectrum Access System

SINR: Signal to Interference-plus-Noise Ratio

SME: Spectrum Management Entity

SON: Self-Organizing Network

SSS: Secondary Synchronization Signal

TDD: Time Division Duplex

UE: User Equipment

UL: Uplink

### (4) UES, BS/APS, RAN, Core Network

As used herein, the term “UE”, or “devices”, or “UE devices” refers to a wide range of user devices having wireless connectivity, such as a cellular mobile phone, an Internet of Things (IOT) device, virtual reality goggles, robotic devices, autonomous driving machines, smart barcode scanners, and communications equipment including for example cell phones, desktop computers, laptop computers, tablets, and other types of personal communications devices. In some cases, the UEs may be mobile; in other cases, they may be installed or placed at a fixed position within a campus location. In other examples, the UEs may include factory sensors installed at fixed locations from which they can remotely monitor equipment such as an assembly line or a robotic arm's movement. Examples of services that can be provided to UEs by a wireless network include:
voice calls;
web browsing;
downloads of document or other information;
video (e.g., YouTube);
social media (e.g., Facebook, Twitter); and
video security cameras, sensors, and many others.

The UEs connect wirelessly over radio communication links to a Radio Access Network (RAN) that typically includes multiple base station/access points (BS/APs) that include antennas, amplifiers, and other electrical and control units for communicating with the UEs. Typically, the radio communication links operate using a Radio Resource Control (RRC) protocol, which is managed by circuitry in the BS/APs.

The term ‘BS/AP” is used broadly herein to include base stations and access points, including at least an evolved NodeB (eNB) of an LTE network or gNodeB of a 5G network, a cellular base station (BS), a Citizens Broadband Radio Service Device (CBSD) (which may be an LTE or 5G device), a Wi-Fi access node, a Local Area Network (LAN) access point, a Wide Area Network (WAN) access point, and should also be understood to include other network receiving hubs and circuitry that provide access to a network of a plurality of wireless transceivers within range of the BS/AP. Typically, the BS/APs are used as transceiver hubs, whereas the UEs are used for point-to-point communication and are not used as hubs. Therefore, the BS/APs transmit at a relatively higher power than the UEs.

A Core Network provides a number of functions and services, including an interface between the RAN and other networks. In one important function, the Core Network provides the UEs in the RAN with access to other devices and services either within its network, or on other networks such as the External PDNs. Particularly, in cellular networks and in private networks, the UEs wirelessly connect with BS/APs in the RAN, and the RAN is coupled to the Core Network. Therefore, the RAN and the Core Network provide a system that allows information to flow between a UE in the cellular or private network and other networks.

In addition to providing access to remote networks and allowing information to flow between the cellular network and the external PDNs, the Core Network may include RAN Control Units that manage the wireless network and provide control of the air interface between the BS/AP and the UEs. The Core Network may also coordinate the BS/APs to minimize interference within the network.

### (5) CBRS Networks

A Citizen's Broadband Radio Service (CBRS) network utilizes the CBRS radio band of 3550-3700 MHz, nominally divided into fifteen channels of 10 MHz each. Particularly, the US Federal Government recently approved use of the CBRS band of the frequency spectrum and finalized rules (Rule 96) that allow general access to the CBRS band. The CBRS rules set forth detailed requirements for the devices that operate in a CBRS network and how they communicate. Both LTE networks and 5G networks can be implemented in CBRS systems. Base stations (BS/APs) within a CBRS network are termed “CBSDs”, and UEs are termed End User Devices (EUDs). All the CBSDs are connected to an operator Core Network by any appropriate communication means, such as wire, fiber optic, wireless radio and/or a PDN, which includes components such as an OAM Server, a SON assist unit, a Domain Proxy, an Automatic Configuration Server (ACS), a Location Database, and other databases, all of which are connected to each other within the operator Core Network by any appropriate means. The operator Core Network is connected to an SAS, which is connected to a Spectrum Database that includes data regarding the spectrum that it is managing; collectively, the SAS and the Spectrum Database are referred to as a Spectrum Management Entity (SME).

In any enterprise wireless network there is a need for efficient use of wireless resources, to provide high levels of service to the UEs attached to the wireless network; i.e., radio resource planning is crucial to provide the QoS promised by a mobile network provider. Self-Organizing Network (SON) technology is an automation technology designed to make the planning, configuration, management, optimization, and healing of mobile RANs simpler and faster; in other words, SONs are RANs that that automatically plan, configure, manage, optimize, and heal themselves. SON networks can offer automated functions such self-configuration, self-optimization, self-healing, and self-protection. SON functionality and behavior has been defined and specified in generally accepted mobile industry recommendations produced by organizations such as 3GPP (3^{rd} Generation Partnership Project) and the NGMN (Next Generation Mobile Networks). An important objective of a SON, generally, is managing networks to more efficiently allocate the available network resources, provide a high level of uninterrupted service to connected UEs, and also minimize interference.

### (6) Wireless Network Rf Environment, Campus Locations

The design of a RAN deployment, and the allocation of resources in a deployed RAN, is greatly dependent upon the RF environment at the campus location where the RAN is deployed. At any RAN deployment, the RF environment can vary due to a variety of causes; for example, physical obstacles like buildings affect the RF environment, also the relative positioning of the transmitters and UEs, interference, campus layout, features, and building construction: walls, materials, carpeted/non-carpeted all can affect the RF environment and may vary widely between locations. In other words, the RF environment can vary greatly within a RAN, and accordingly each BS/AP may see a different path loss.

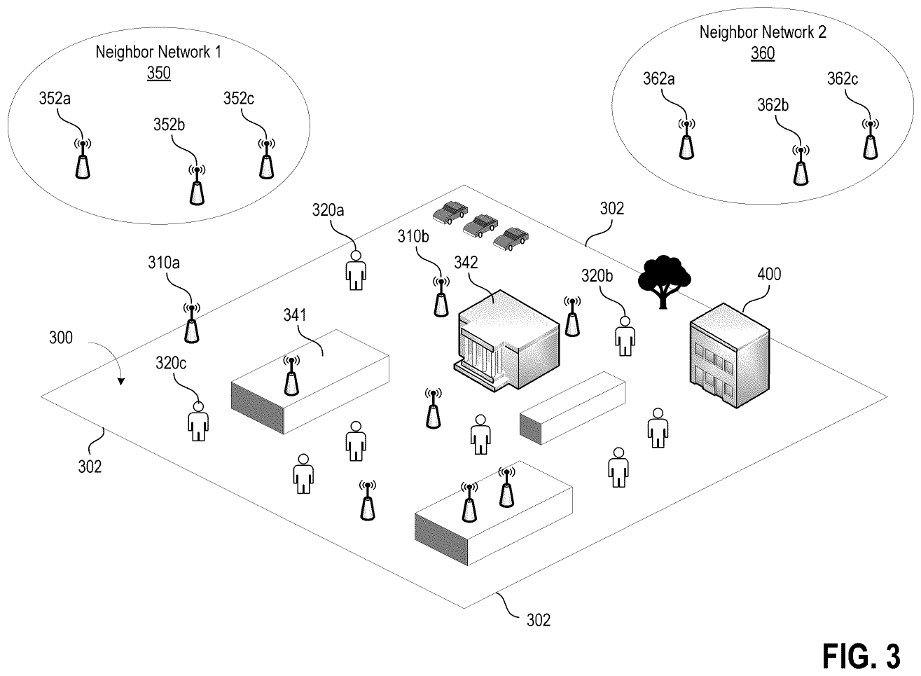

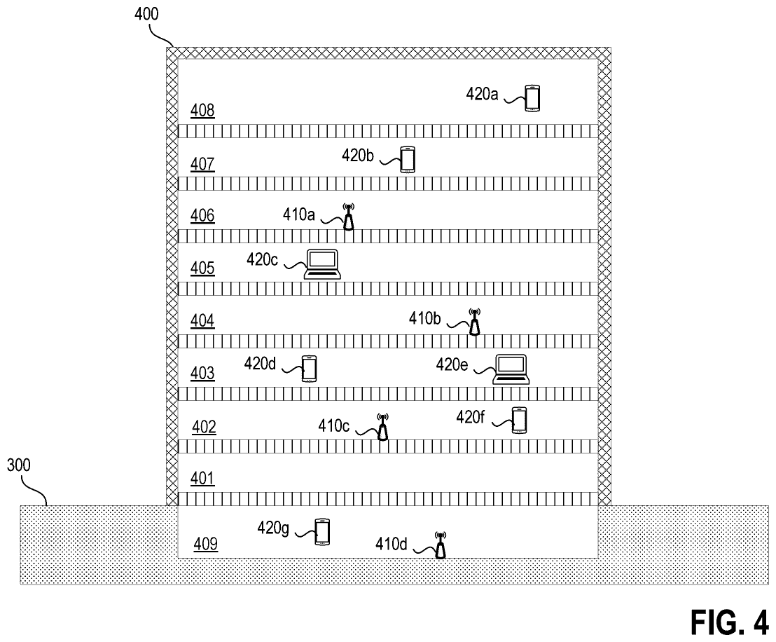

Following are examples of a campus location and a building in which a RAN is deployed, all of which contribute to the RF environment. Particularly, FIG. 3 is a perspective illustration of a campus location 300 that has wireless coverage and FIG. 4 is a cross-sectional view of a building 400 on the campus location 300.

FIG. 3 is a perspective illustration of a campus location 300 in which a plurality of BS/APs including at least a first BS/AP 310a, a second BS/AP 310b (collectively 310) of an Enterprise Network (EN) are installed to provide wireless coverage to a plurality of mobile users such as a first user 320a a second user 320b, and a third user 320c (referred to collectively as 320). Each mobile user 320 may be carrying one or more UEs such as a mobile phone, laptop computer, or some other device that can be connected to the EN.

The campus location 300 defines a boundary perimeter 302, and the BS/APs 310 are deployed within the boundary 302. The positions and configuration of the BS/APs 310 deployed within the campus location 300 are selected to provide wireless coverage to the plurality of users 320 for the EN. The BS/APs 310 may be installed indoors and outdoors, and may comprise any type of BS/AP. The BS/APs 310 generally provide wireless coverage substantially throughout the campus location 300, indoor and outdoor, with coverage usually extending to surrounding areas at least to some extent. In one embodiment the BS/APs 310 comprise CBSDs and the EN includes a CBRS network. In some embodiments some of the BS/APs 310, particularly the BS/APs installed indoors, have a UE built into them. These built-in UEs can be used for making measurements that can be used to determine the MN footprint information, as described herein.

Outside the campus location 300, there may be a number of neighbor networks. FIG. 3 illustrates a first neighbor network 350 that include a plurality of BS/APs 352 and a second neighbor network 360 that includes a plurality of BS/APs 362. The wireless communication signals from these neighbor networks 350, 360 can interfere with wireless communications through the EN's campus location 300, particularly in areas near to the neighboring networks.

FIG. 4 is a cross-sectional view of a building 400 on the campus location 300 in which a plurality of BS/APs of the RAN are installed on different floors. In this example, a first BS/AP 410a is installed on the sixth floor 406, a second BS/AP 410b is installed on the fourth floor 404, a third BS/AP 410c is installed on the first floor 401, and a fourth BS/AP 410d is installed in the basement 409. Building construction (walls, materials, carpeted/non-carpeted) can vary widely between locations, and all can affect the RF environment. In some embodiments, the indoor BS/APs 410 have a UE built into them, which can be used for making measurements.

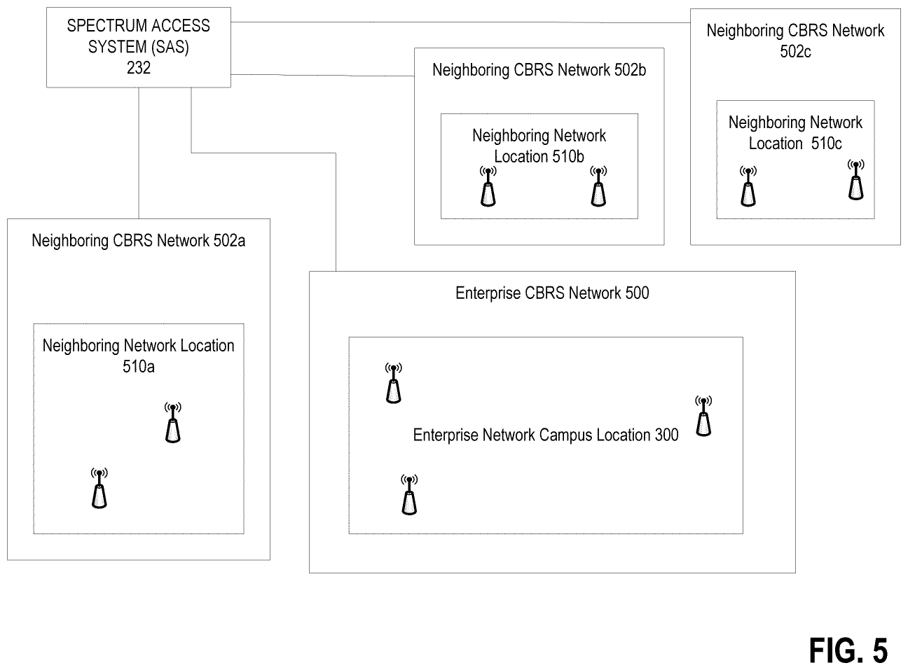

FIG. 5 is a block diagram showing an example of a CBRS network including an interconnected system of neighboring networks including the SAS 232, an Enterprise CBRS Network 500 including a plurality of BS/APs and UEs communicating with the BS/APs, and a plurality of neighboring CBRS enterprise networks 502a, 502b, 502c, each having respectively at least one neighbor network location 510a, 510b, and 510c, each location including a plurality of BS/APs and UEs communicating with the BS/APs.

### (7) Silent Mode Measurements

To measure impact from the neighboring networks, all the CBSDs/UEs go into silent mode at the same time, in a coordinated fashion. The silence period is defined in the Enterprise Network, and each of the CBSDs/UEs are coordinated to go into silence during that period. During the silence period, the CBSDs receive and listen to signals on one or more of the channels, as designated by the Silent Mode Controller.

### (8) Silence Period Mechanisms:

A silence period is created in the Enterprise Network, and defined based at least partly on the current or expected traffic nature and load, and the TDD configurations operating in the network. For example, if the network is experiencing (or is expected to experience) a larger amount of UL traffic than DL traffic, then the DL sub-frame slot 6 is preferably used as a silent period, and if the network is experiencing (or is expected to experience) a larger amount of DL traffic than UL traffic, then the sub-frame slot 3 is preferably used as a silent period.

The energy on the channel is determined by sensing the communication medium (e.g., a wireless channel) at each CBSD. Hence, there needs to be a coordination between CBSDs in the network to sense the communication medium, otherwise, sensing the channel can lead to false detection or wrong decision-making. This coordination can be controlled by the Silent Mode Controller.

### (9) Energy Thresholds

For determining the relative closeness of a neighboring network, an interference level may be determined. In one embodiment, for determining the relative closeness of a neighboring network, two energy thresholds for interference may be defined: a High Energy Threshold at −72 dBm, and a Low Energy Threshold at −88 dBm.

A high energy threshold may be observed if there is any neighboring CBSD deployed nearby, and it operates on the same channel. During the time of silence at CBSDs in the network, if the energy level of the interference observed on the channel is less than −72 dBm, this high energy level indicates that the interference is from a neighboring network that may be very close.

A low energy threshold may be observed if there is any neighboring CBSD deployed nearby, and it operates on the same channel. During the time of silence of CBSDs in our network, if the energy level of the interference observed on the channel is more significant than −88 dBm, this indicates that the interference is from a neighboring network that is farther away.

### (10) Silent Period for Measuring Neighboring Network Impact

To measure the neighboring network impact, all the CBSDs and UEs in the EN go to silent mode at the same time in coordinated fashion. The Enterprise Network may include a Silent Mode Controller to perform this function.

### (11) Channels to be “Monitored” by Cbsds in Silent Mode:

In the best-case scenario, the silent period can be used to test only those channels that are not available (from the SAS). There may be no need for the operators to perform (monitor) the silent period on all channels. Only the silent period can be performed dependent upon the non-availability of the channels allocated the EN by the SAS.

In the worst-case scenario, if all the channels are occupied by a nearby GAA network, then the silent period operation on all channels is necessary to choose the best channel operation within the EN network.

### (12) Duration of Silent Period Per Channel:

Depending upon the nature of traffic (DL/UL), at least one sub-frame i.e., 1 ms duration (slot 3 or slot 6) is used as a silent period in the 10 ms interval of frame duration. In order to decide, three sub-frames i.e., 3 ms are muted in the total of 30 ms frame duration. Hence, there will be three Energy Detection (ED) values measured and averaged over 3. Based on the value observed with the corresponding threshold −72 and −88 dBm, the high interference, low interference or no interference channels can be identified.

Duration of Silent Period on all fifteen CBRS Channels: Depending upon the nature of traffic, at least one sub-frame i.e., 1 ms duration (slot 3 or slot 6) is used as the silent period in the 10 ms interval of frame duration. In order to decide, three sub-frames i.e.; 3 ms may be muted in the total of the 30 ms frame duration per channel. Hence, there will be three ED values measured and averaged over three. So, in total for fifteen CBRS channels, the total required duration in one embodiment is 450 ms (i.e., 15*30 ms).

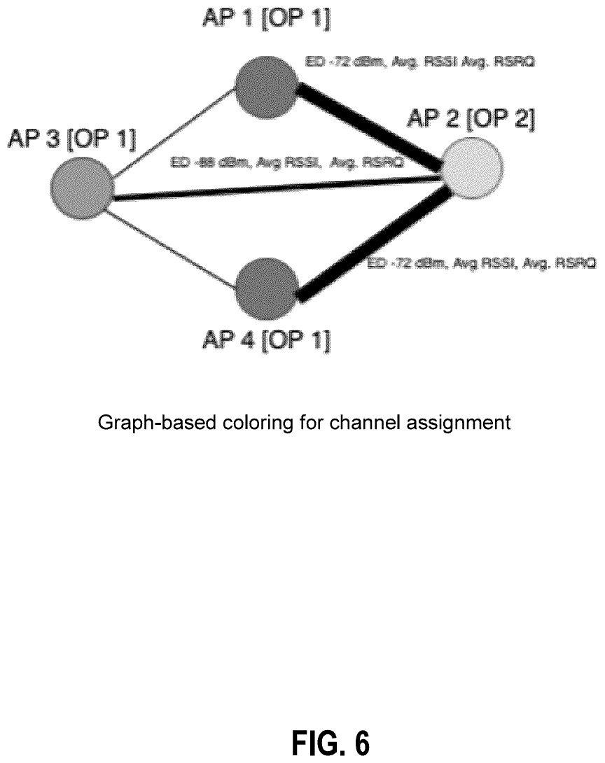

See FIG. 6, which is an example of graph-based coloring for channel assignment.

### (13) Metrics Measured During Dl and Ul

Primary metrics (signal qualities) such as ED, RSSI, and RSRQ are the key metrics that can be used to identify the impact on each channel to be measured.

RSSI: The RSSI can give the signal impact on the wider bandwidth. This will be very helpful if the CBSD has capable to operate on 100 MHz (like in 5G), the feedback from the UE, can give the channel impact on the entire 100 MHz channels (assuming the UE has the capability of 100 MHz support, right now, we have the support up to 40 MHz feedback). This operation can be done in less time than the ED measurement.

RSRQ: The metric RSRQ gives the quality of the channel, if the RSRQ value is very low this indicates there are nearby CBSDs that are densely deployed on the same channel. But this metric cannot give feedback on the wider channel.

In one embodiment, we use the ED, RSSI and RSRQ during the silent periods, to identify (measure) the channel quality.

### (14) Self-Organizing Network (Son) Unit:

Each CBSD in the enterprise network passes its collected ED, RSSI and RSRQ interference data as feedback for each channel, to the SON unit. Using this data, the SON can determine signal quality and perform the following important actions:
1. Use the feedback to plan, or re-plan, the Enterprise Network in terms of channel allocation, bandwidth operation (20, 40, 60, 80, or 100 MHz), and transmission power to provide better network performance;
2. Use the feedback to provide information to one or more of the neighboring networks, and request (or instruct) action to mitigate interference from the neighboring CBSDs; and
3. Use the feedback and request the SAS to take immediate action on the nearby CBSDs, for example due to high levels of interference.

The interference data and other information can be processed by the Enterprise Network, and provided to the SAS, which provides the opportunity to extend the silencing behavior to be coordinated and triggered through the SAS for neighborhood deployments, (and preferably the full neighborhood) to enable measurements being done across deployments.

### (15) Measuring CBRS Deployment

### (16) Approach 1

In this section, CBRS enterprise deployment is measured, and the collected feedback interference data is provided to the SON, where it can be used to improve the SON's network organizing ability. We assume all the BS/APs are in coordination with the SON. Based on the UL/DL and grant request and access, the BS/AP knows the active allocation of Resource Blocks (RBs). Based on the initial channel grant from the SAS, the SON allocates channel and transmission power for efficient operation, using the available information. Due to the dynamicity of the network and RF condition, it is useful or necessary to monitor the network, and if changes are observed, assist the SON to make a decision in re-planning or changing power accordingly.

In a first approach, based on the initial channel assignment configuration, the SON can look for a CBSD footprint based on reuse of the same channel. The SON may be aware of the active transmission, or BS/APs can update this information in one bit. Then, the SON can coordinate with the other BS/APs to listen to the transmission on the future frames. This process is repeated for each BS/AP active transmission. In addition to the ED, RSSI, RSRQ, the RSRP measurements can be used to assist the SON.

The same channel approach is repeated for each channel and each CBSD in the network.

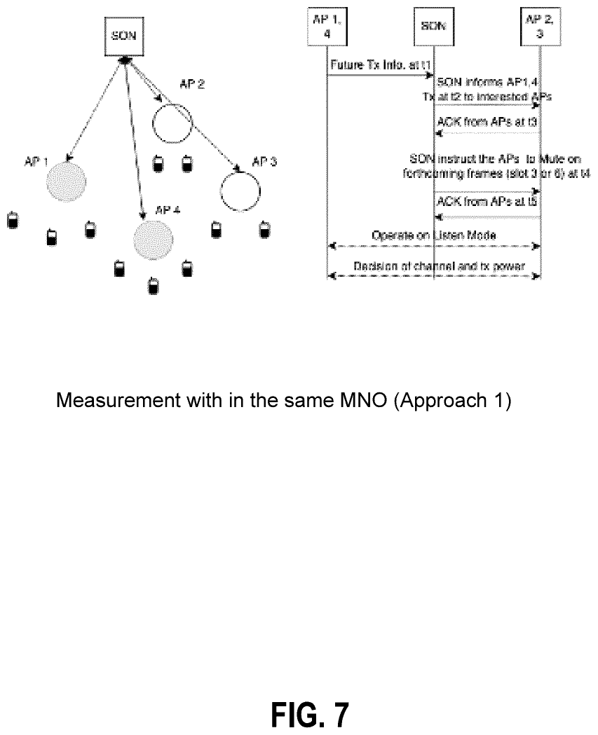

FIG. 7 is an example of measurement within the same MNO (Approach 1)

### (17) Approach 2

In a second approach to measurement of the EN deployment, a silence period is created for all BS/APs except for one. The silence periods may be created for one UL slot and one DL slot. The listening process is performed with only one BS/AP operating and the other BS/APs measuring, which can provide a clear view of the footprint of each BS/AP. The measurement may be done on the same frequency as the BS/AP is assigned to transmit/receive, and on the actual operational channel of the BS/AP.

### (18) Using Ue-Based Measurement Reports to Improve Son Performance

To improve the SON performance, feedback data measurements of reliable UE groups, based on the stability of the RF condition, may be used. If the deployment node on the field is CPE, then the UE can decode the signal up to −118 dBm. This can help the SON to give some understanding about the far interferer.

Note: All the above-proposed approaches can be extended to the 5G/NR format as well. This approach can be even extended to all slots and done for a full frame at a different time with one slot at a time. Also need to account for NR-NR, LTE-LTE, and NR-LTE conflict detection.

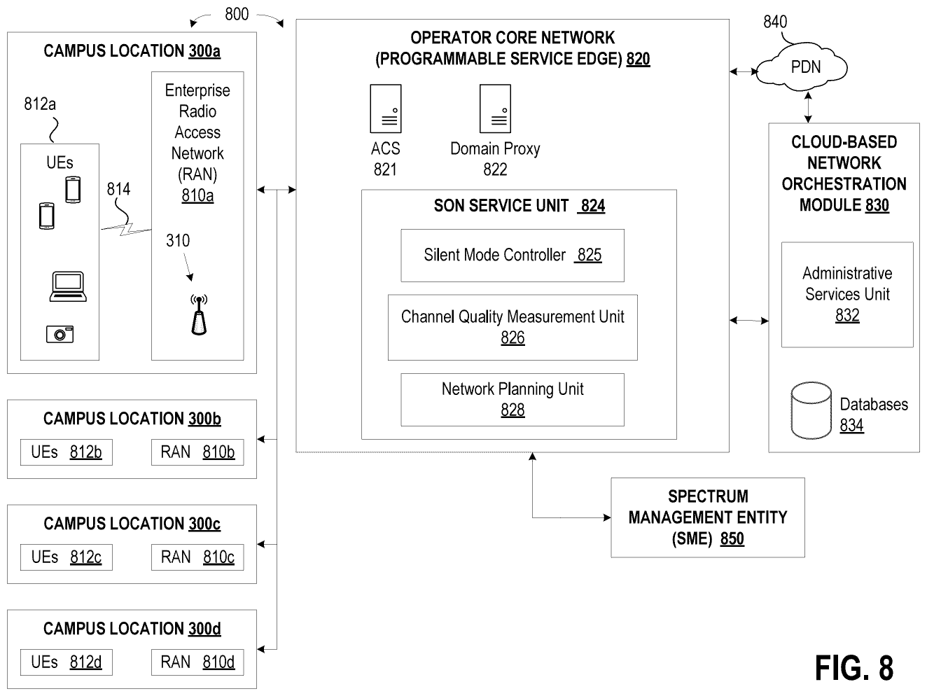

### (19) FIG. 8 En Implementation Diagram

FIG. 8 is a block diagram of an implementation of an Enterprise Network (EN) 800 that includes processing units such as units for creating silence periods, measuring the interference data, and re-planning the network.

The EN 800 includes one or more Radio Access Networks (RANs) 810 each located on a separate campus location 300. Each RAN 810 comprises a plurality of BS/APs 310 that are wirelessly connected to a plurality of UEs 812. The RANs 810 are connected to an Operator Core Network 820 by any suitable connection. For example, all the BS/APs 310 in the RAN 810 may be connected by any appropriate communications means, such as wire, fiber optic, and wireless radio, which is then connected to the Core Network 820. The BS/APs in the RANs 810 are connected to, and operated and controlled by, the Core Network 820. Some of the RAN services may be provided by the Core Network 820. The RANs 810 provide wireless connection and services to a plurality of UEs on the campus locations 300. A user interface (not shown) may be provided and connected to the Core Network 810 for administration of the EN 800.

In an enterprise network deployment, the BS/APs 310 and elements of the RAN 810 will be located on the campus location 300, and it is very likely that the Core Network 820 will be physically located at or near the enterprise location, especially in large or multiple deployments in the same area. However, for smaller deployments, or for multiple small deployments, it may be more cost effective to physically locate the Core Network, or one or more components of the Core Network remotely from the enterprise location.

In some embodiments the Core Network 820 is connected to a Network Orchestration module 830 that may include an Administrative Service Unit 832 for remote administration of the enterprise network, databases 834, other components as may be necessary or useful, and other functional units such as machine learning and artificial intelligence units. The Orchestration Module 830 is connected to the Core Network 820 by any appropriate communications means, such as a PDN 840. Generally, the Network Orchestration Module 830 supports the Core Network 820 and can provide additional services.

The Core Network 820 (which may also be called a Programmable Service Edge or “PSE”) provides a variety of services for the EN 800 using a plurality of components connected to each other by any appropriate means. In the illustrated embodiment of FIG. 8, the Core Network 820 includes an Automatic Configuration Server (ACS) 821, a domain proxy 822, and a SON (Self Organizing Network) service unit 824 that includes a Silent Mode Controller 825, a Channel Quality Measurement Unit 826, and a Network Planning Unit 828, which can be used for planning and replanning the RAN. In some embodiments, these units may be located offsite.

In addition, the Core Network 820 may include components (not shown) such as an MMF (Mobility Management Function) unit, a monitoring service unit, an SGW/PGW (Serving Gateway/Packet Data Network Gateway) unit, a TR069 unit, a KPI (Key Performance Indicator) service unit, databases such as a Location Database, and other units such as an Operations, Administration, and Maintenance (OAM) Server, and units for other services. The Core Network 820 may be connected to a Spectrum Management Entity (SME) 850, for example it may be connected to the SME 234 shown in FIG. 2.

### Programmable Embodiments

Some or all aspects of the invention, for example aspects of the algorithmic characteristics of the invention, may be implemented in hardware or software, or a combination of both (e.g., programmable logic arrays). Unless otherwise specified, the algorithms included as part of the invention are not inherently related to any particular computer or other apparatus. In particular, various general purpose computing machines may be used with programs written in accordance with the teachings herein, or it may be more convenient to use a special purpose computer or special-purpose hardware (such as integrated circuits) to perform particular functions. Thus, embodiments of the invention may be implemented in one or more computer programs (i.e., a set of instructions or codes) executing on one or more programmed or programmable computer systems (which may be of various architectures, such as distributed, client/server, or grid) each comprising at least one processor, at least one data storage system (which may include volatile and non-volatile memory and/or storage elements), at least one input device or port, and at least one output device or port. Program instructions or code may be applied to input data to perform the functions described in this disclosure and generate output information. The output information may be applied to one or more output devices in known fashion.

Each such computer program may be implemented in any desired computer language (including machine, assembly, or high-level procedural, logical, or object-oriented programming languages) to communicate with a computer system, and may be implemented in a distributed manner in which different parts of the computation specified by the software are performed by different computers or processors. In any case, the computer language may be a compiled or interpreted language. Computer programs implementing some or all of the invention may form one or more modules of a larger program or system of programs. Some or all of the elements of the computer program can be implemented as data structures stored in a computer readable medium or other organized data conforming to a data model stored in a data repository.

Each such computer program may be stored on or downloaded to (for example, by being encoded in a propagated signal and delivered over a communication medium such as a network) a tangible, non-transitory storage media or device (e.g., solid state memory media or devices, or magnetic or optical media) for a period of time (e.g., the time between refresh periods of a dynamic memory device, such as a dynamic RAM, or semi-permanently or permanently), the storage media or device being readable by a general or special purpose programmable computer or processor for configuring and operating the computer or processor when the storage media or device is read by the computer or processor to perform the procedures described above. The inventive system may also be considered to be implemented as a non-transitory computer-readable storage medium, configured with a computer program, where the storage medium so configured causes a computer or processor to operate in a specific or predefined manner to perform the functions described in this disclosure.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” or “unit” does not imply that the components or functionality described or claimed as part of the module or unit are all configured in a common package. Indeed, any or all of the various components of a module or unit, whether control logic or other components, can be combined in a single package or separately maintained and can further be distributed in multiple groupings or packages or across multiple locations.

Additionally, the various embodiments set forth herein are described with the aid of block diagrams, flowcharts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of determining channel quality at a campus location of a wireless Enterprise Network that includes a plurality of BS/APs, at least some of which communicate using wireless channels, comprising:
silencing a channel on the plurality of the BS/APs in the Enterprise Network; and
listening to channel signals on the silenced BS/APs.

2. The method of claim 1 wherein the silencing of channels is coordinated by the Enterprise Network.

3. The method of claim 1 further comprising silencing a plurality of UEs in the Enterprise Network.

4. The method of claim 1 wherein the Enterprise Network is operating as a CBRS network.

5. A method of measuring wireless signals on channels from neighboring wireless networks at a campus location of a wireless Enterprise Network that includes a plurality of BS/APs, at least some of which communicate using the wireless channels, comprising:
silencing a plurality of the BS/APs in the Enterprise Network;
listening to signals on the silenced BS/APs and providing interference data to the Enterprise Network; and
responsive to the interference data determining an interference level from the neighboring networks.

6. The method of claim 5 further comprising communicating the interference level to the neighboring wireless networks.

7. The method of claim 5 wherein the silencing of channels is coordinated by the Enterprise Network.

8. The method of claim 5 further comprising silencing a plurality of UEs in the Enterprise Network.

9. The method of claim 5 wherein the Enterprise Network is operating as a CBRS network.

10. The method of claim 5 further comprising re-organizing the wireless Enterprise Network responsive to the interference data.

11. A SON (resource allocation system) for allocating wireless resources to each of the BS/APs of a Radio Access Network (RAN) situated in a campus location of a wireless Enterprise Network (EN), the SON comprising:
a Silent Mode Controller for coordinating silence periods of the BS/APs responsive to traffic nature, load, the TDD configuration;
a communication means for communicating the silence periods to the BS/APs and receiving interference data from the BS/APs for each channel;
a Channel Quality Measurement unit, responsive to the interference data, for determining channel quality.
